(19) United States
(12) Patent Application Publication
(10) Pub. No.: US 2017/0131979 A1
(43) Pub. Date: May 11, 2017

(54) VARIABLE DEFINITION MODIFICATION DEVICE AND METHOD FOR PROCESS MODEL INTEGRATION SYSTEM

(71) Applicant: Institute For Information Industry, Taipei (TW)

(72) Inventor: Yan Ming CHEN, Tainan City (TW)

(21) Appl. No.: 14/951,855

(22) Filed: Nov. 25, 2015

(30) Foreign Application Priority Data
Nov. 5, 2015 (TW) 104136478

(51) Int. Cl. G06F 9/44

(52) U.S. Cl. CPC G06F 8/35

(57) ABSTRACT

A variable definition modification device and a method for a process model integration system are provided. The device stores a plurality of process model definition files corresponding to a plurality of process models. Each of the process models includes an artifact including an original variable definition and a process model identity. The device creates a variable definition integration table recording a new variable definition, the original variable definitions and the process model identities, and create a variable definition location table including variable definition locations. The new variable definition and the original variable definitions correspond to a same variable. The device modifies one of the original variable definitions into the new variable definition in the corresponding process model definition file according to the variable definition integration table and the variable definition location table if the original variable definition is different from the new variable definition.

### PRIORITY

This application claims priority to Taiwan Patent Application No. 104136478 filed on Nov. 5, 2015, which is incorporated herein for reference in its entirety.

### FIELD

The present invention relates to a variable definition modification device and method. More particularly, the present invention relates to a variable definition modification device and method for a process model integration system.

### BACKGROUND

The concept of Business Process Management (BPM) has now been widely adopted in performance management of enterprises and the planning of e-company. The application scope of BPM includes the financial industries, High-Tech industries, medical industries, manufacturing industries, circulation industries, national defense logistics management and so on. According to the definition made by the Gartner Group, BPM means a complete set of tools and services, which not only provide working process analysis and integration of information systems within enterprises, but also provide application integration of external business partners to satisfy the need for cooperation between enterprises in the future.

In practice, BPM usually requires integration of process models of various functions. Generally, the larger the scale of BPM is, the more the process models to be integrated will be. However, as the scale of BPM is larger, the desired process models usually are not developed by a same developer (or a same development team), so one variable may correspond to several different variable definitions in these process models. In this case, if no appropriate processing is made on the different variable definitions for the same variable, it would be impossible to transfer the same variable between the different process models in as integrating the process models.

For the aforesaid problem, two solutions have been provided by the conventional variable definition processing technologies. The first is to adopt a same preset variable definition rule to define variables when those process models are developed by different developers. Although this can solve the aforesaid problem, it is difficult in practice to force all the developers to adopt a same variable definition rule for definition of variables. Therefore, the first solution is lack of flexibility in use. The second solution is to create a variable definition correspondence table in advance before any two process models are integrated so that when a variable is transferred from one of the process models to the other, the other process model can know from the variable definition correspondence table that the variable is a same variable from the one process model. However, complexity of the variable definition correspondence table is directly proportional to the number of process models to be integrated. Therefore, as the number of process models to be integrated increases, a large amount of computing resources will be consumed to create the variable definition correspondence table.

Accordingly, an urgent need exists in the art to provide a more effective variable definition processing technology for a process model integration system.

### SUMMARY

The disclosure includes a variable definition modification device for a process model integration system. The variable definition modification device comprises a storage, a variable definition integration recorder, a variable definition location recorder and a variable definition modifier. The variable definition integration recorder, the variable definition location recorder and the variable definition modifier may be electrically connected to the storage. The storage may be configured to store a plurality of process model definition files corresponding to the process model integration system, and each of the process model definition files corresponds to a process model. Each of the process models comprises an artifact, and each of the artifacts comprises an original variable definition and a process model identity. The variable definition integration recorder may be configured to create a variable definition integration table in the storage, and the variable definition integration table may comprise a new variable definition, the original variable definitions and the process model identities. The new variable definition and the original variable definitions correspond to a same variable. The variable definition location recorder may be configured to create a variable definition location table in the storage, and the variable definition location table may comprise variable definition locations where the original variable definitions are located in the corresponding process model definition files respectively. The variable definition modifier may be configured to modify one of the original variable definitions into the new variable definition in the corresponding process model definition file according to the variable definition integration table and the variable definition location table if the original variable definition is different from the new variable definition.

The disclosure includes a variable definition modification method for a process model integration system. The variable definition modification method may be used in a variable definition modification device, and the variable definition modification device may comprise a storage, a variable definition integration recorder, a variable definition location recorder and a variable definition modifier. The variable definition modification method may comprise the following steps of: storing, by the storage, a plurality of process model definition files corresponding to a process model integration system, each of the process model definition files corresponding to a process model, each of the process models comprising an artifact, and each of the artifacts comprising an original variable definition and a process model identity; creating, by the variable definition integration recorder, a variable definition integration table in the storage, the variable definition integration table comprising a new variable definition, the original variable definitions and the process model identities, and the new variable definition and the original variable definitions corresponding to a same variable; creating, by the variable definition location recorder, a variable definition location table in the storage, the variable definition location table comprising variable definition locations where the original variable definitions are located in the corresponding process model definition files respectively; and modifying, by the variable definition modifier, one of the original variable definitions into the new variable definition in the corresponding process model definition file according to the variable definition integration table and the variable definition location table if the original variable definition is different from the new variable definition.

The disclosure further includes a variable definition integration table which may be provided for a process model integration system used for integrating a plurality of process models, and the variable definition integration table is configured to record a new variable definition, at least one original variable definition and at least one corresponding process model identity for a same variable. In this way, not only correspondence of variable definitions can be created for a same variable, but also a corresponding process model of each of the original variable definitions can be recorded. When one of the original variable definitions needs to be modified, the one of the process models to which the original variable definition to be modified corresponds (i.e., the process model definition file to which the original variable definition corresponds) can be known immediately. In the present invention, a variable definition location table may also be provided, and the variable definition location table is configured to record a variable definition location where each of the original variable definitions is located in the corresponding process model definition file. Thus, when one of the original variable definitions needs to be modified, the location where the original variable definition is located in the corresponding process model definition file can be known immediately. In the present invention, if one of the original variable definitions is different from the new variable definition for a same variable, the original variable definition may be modified into the new variable definition in the corresponding process model definition file according to the variable definition integration table and the variable definition location table. Thereby, the same variable can correspond to the same variable definition in all of the process models. Based on these operations, the present invention can indeed provide a more effective variable definition processing technology for the process model integration system.

The foregoing is a summary of some aspects of the present invention (including the problem to be solved, the means to solve the problem and the effect of the present invention) to provide a basic understanding of these aspects. However, this is not intended to contemplate all aspects of the present invention. Additionally, the summary provided above is neither intended to identify key or essential elements of any or all aspects of the present invention, nor intended to describe the scope of any or all aspects of the present invention. This summary is provided only to present some concepts of some aspects of the present invention in a simple form and as an introduction to the following detailed description.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating an exemplary example of a process model integration system according to one or more embodiments of the present invention;

FIG. 2A is a schematic view illustrating an exemplary example of an integrated process model shown in FIG. 1 according to one or more embodiments of the present invention;

FIG. 2B is a schematic view illustrating another exemplary example of an integrated process model shown in FIG. 1 according to one or more embodiments of the present invention;

FIG. 3 is a block diagram illustrating an exemplary example of the variable definition modification device shown in FIG. 1 according to one or more embodiments of the present invention;

FIG. 4 is a schematic view illustrating an exemplary example of the storage shown in FIG. 3 according to one or more embodiments of the present invention;

FIG. 5 is a schematic view illustrating an exemplary example of the variable definition integration table shown in FIG. 4 according to one or more embodiments of the present invention;

FIG. 6 is a schematic view illustrating an exemplary example of the variable definition location table shown in FIG. 4 according to one or more embodiments of the present invention; and

FIG. 7 is a flowchart diagram illustrating an exemplary example of a variable definition modification method for a process model integration system according to one or more embodiments of the present invention.

### DETAILED DESCRIPTION

In the following description, the present invention will be explained with reference to example embodiments thereof. However, these example embodiments are not intended to limit the present invention to any specific examples, embodiments, environment, applications, structures, processes or steps described in these example embodiments. In the attached drawings, elements unrelated to the present invention are omitted from depiction. In addition, dimensional relationships among individual elements in the attached drawings are illustrated only for ease of understanding, but not to limit the actual scale. Unless otherwise stated, like reference numerals correspond to like elements in the following descriptions.

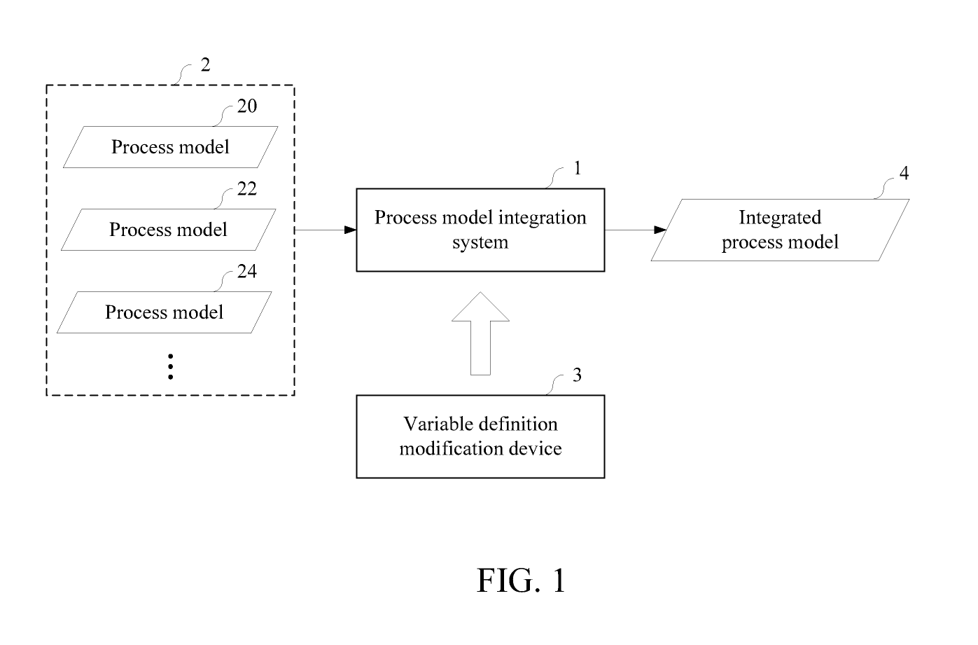

An embodiment of the present invention (called “the first embodiment” hereinafter) is a variable definition modification device for a process model integration system. FIG. 1 is a block diagram illustrating an exemplary example of a process model integration system according to one or more embodiments of the present invention. Referring to FIG. 1, a process model integration system 1 may be configured to integrate a plurality of process models 2 (including process models 20, 22, 24) into an integrated process model 4. During the process of integrating the plurality of process models 2 (including the process models 20, 22, 24, . . . ) into the integrated process model 4 by the process model integration system 1, a variable definition modification device 3 may be configured to modify different variable definitions that correspond to a same variable in the plurality of process models 2. The variable definition modification device 3 may be either a part of or independent of the process model integration system 1. If the variable definition modification device 3 is a part of the process model integration system 1, the variable definition modification device 3 and all internal components of the process model integration system 1 may be directly or indirectly electrically connected with each other and communicate with each other. If the variable definition modification device 3 is independent of the process model integration system 1, the variable definition modification device 3 may be connected to the process model integration system 1 via various wired or wireless networks or various wired or wireless connection interfaces to communicate therewith.

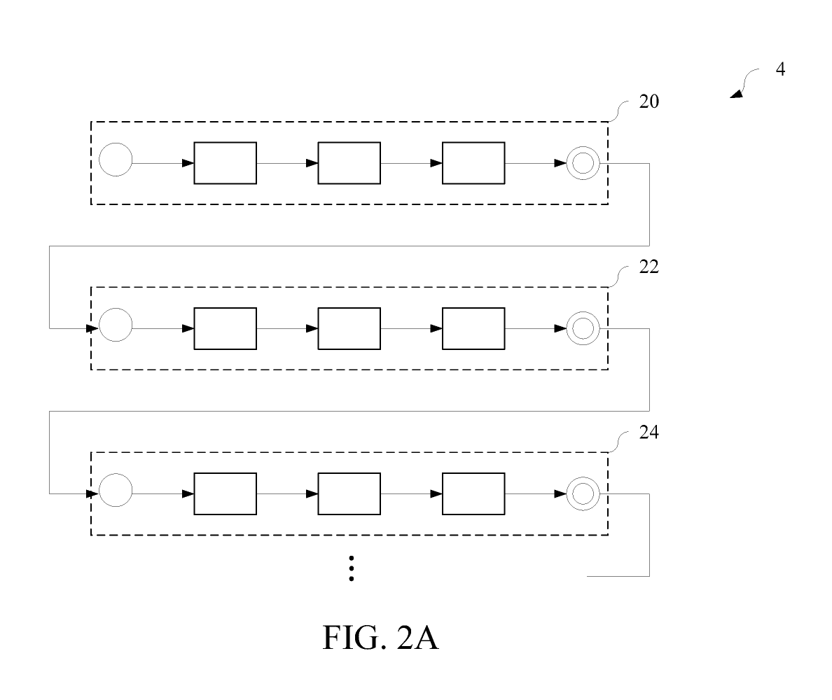

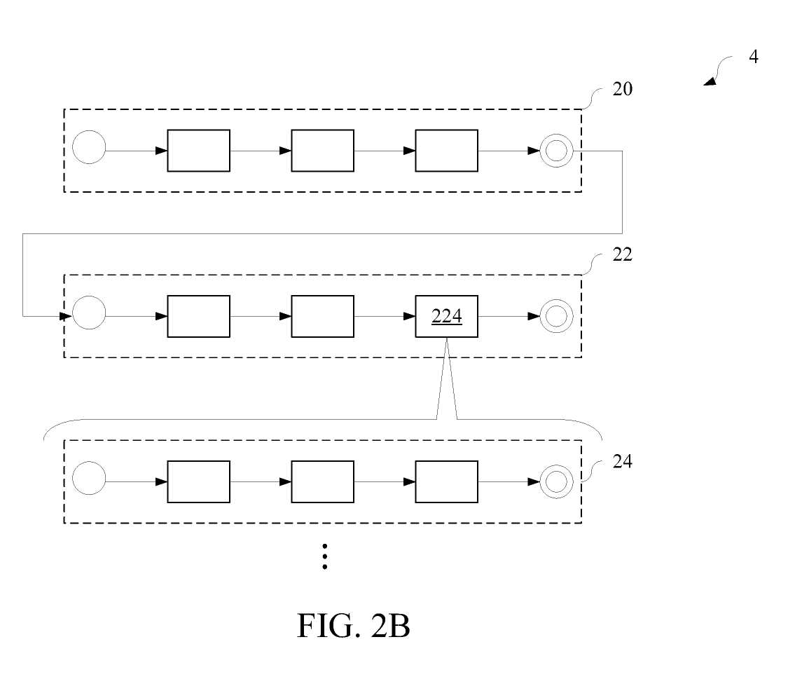

The process model integration system 1 may integrate the plurality of process models 2 into the integrated process model 4 in various ways. Hereinafter, two implementations of integrating the plurality of process models 2 into the integrated process model 4 will be described by taking FIG. 2A and FIG. 2B as examples, but this is not for the purpose of limitation. FIG. 2A is a schematic view illustrating an exemplary example of the integrated process model 4 shown in FIG. 1 according to one or more embodiments of the present invention. Referring to FIG. 2A, the process model integration system 1 may cascade the plurality of process models 2 in sequence to form the integrated process model 4. For example, an end point of the process model 20 may be connected to a start end of the process model 22, then an end point of the process model 22 is connected to a start point of the process model 24, and so forth. FIG. 2B is a schematic view illustrating another exemplary example of the integrated process model 4 shown in FIG. 1 according to one or more embodiments of the present invention. Referring to FIG. 2B, instead of cascading the plurality of process models 2 in sequence, the process model integration system 1 may replace a certain task in one of the process models with another of the process models to form the integrated process model 4. For example, a task 224 in the process model 22 may be replaced by the process model 24.

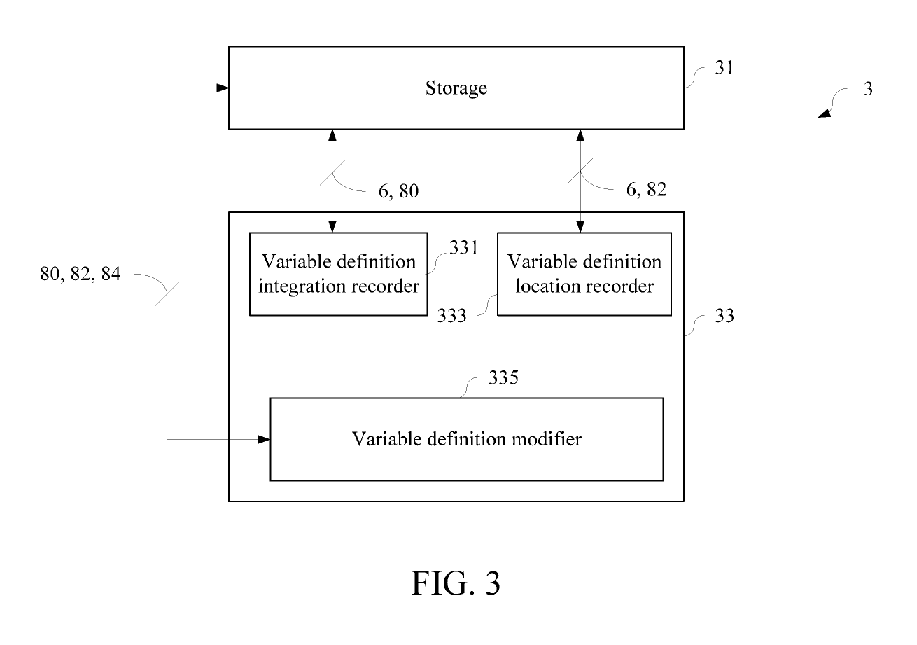

FIG. 3 is a block diagram illustrating an exemplary example of the variable definition modification device 3 shown in FIG. 1 according to one or more embodiments of the present invention. Referring to FIG. 3, the variable definition modification device 3 may comprise a storage 31, a variable definition integration recorder 331, a variable definition location recorder 333 and a variable definition modifier 335. Preferably, the variable definition integration recorder 331, the variable definition location recorder 333 and the variable definition modifier 335 are a part of a processor 33. In the variable definition modification device 3, the storage 31, the variable definition integration recorder 331, the variable definition location recorder 333 and the variable definition modifier 335 may be directly or indirectly electrically connected with each other either, and communicate with each other. Herein, “directly electrically connected” means that the two components are electrically connected without any other intervening component therebetween, and “indirectly electrically connected” means that the two components are electrically connected with an intervening component therebetween.

The variable definition modification device 3 may be a computer-related device, for example but not limited to, a desktop computer, a laptop computer, a tablet computer, a notebook computer, a smartphone or the like. Therefore, the variable definition modification device 3 may have a computing component such as any of various general-purpose processors or microprocessors, and execute various computations and processing via the computing component. The processor 33 and the variable definition integration recorder 331, the variable definition location recorder 333 and the variable definition modifier 335 comprised therein may comprise a part of the aforesaid computing component such as any of various general-purpose processors or microprocessors, and are configured to accomplish corresponding operations described below.

The variable definition modification device 3 may further comprise a storage component such as any of various general-purpose non-volatile storages and/or volatile storages, and store various data via the storage component. The storage 31 may comprise the aforesaid storage component such as any of various general-purpose non-volatile storages and/or volatile storages, and is configured to accomplish corresponding operations described below.

The variable definition modification device 3 may also have any of various general-purpose input/output components, and receive data from and output data to the outside via the input/output components. The variable definition modification device 3 may drive the computing component, the storage component, the input/output components or the like according to processes implemented by software, firmware, programs, algorithms or the like so as to execute corresponding operations.

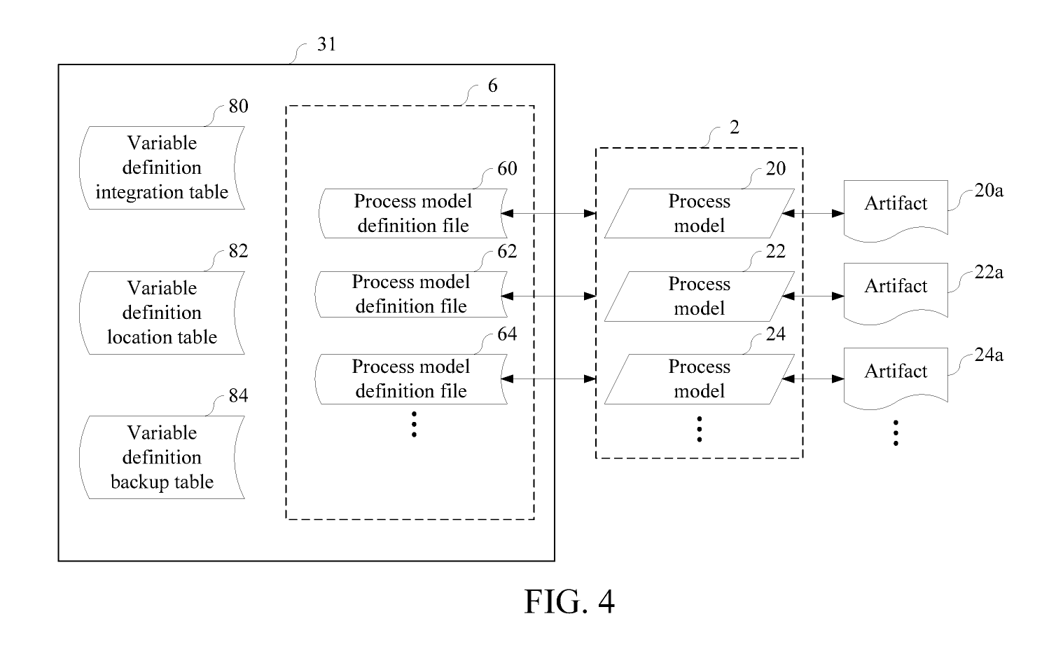

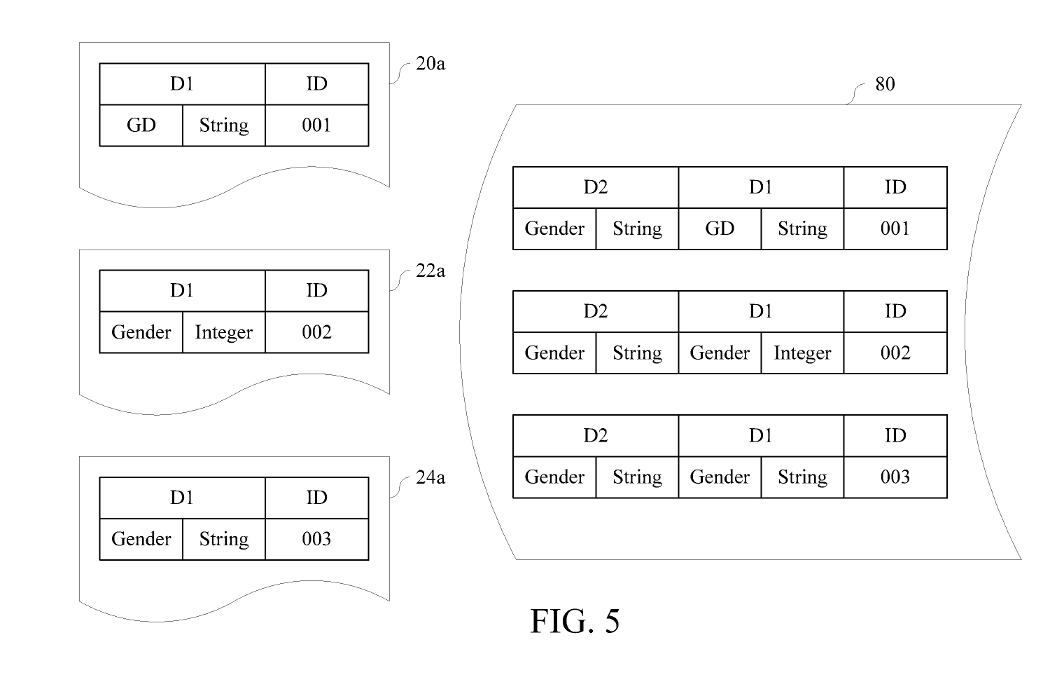

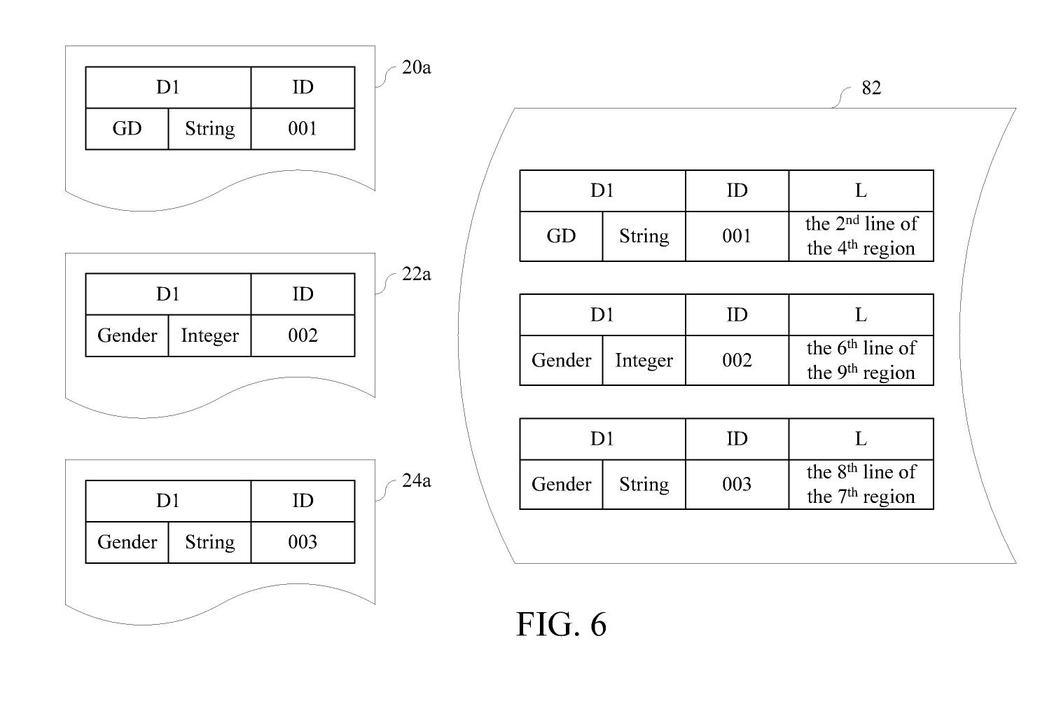

Hereinafter, various operations of the variable definition modification device 3 will be described with reference to FIG. 3, FIG. 4, FIG. 5 and FIG. 6. FIG. 4 is a schematic view illustrating an exemplary example of the storage shown in FIG. 3 according to one or more embodiments of the present invention. FIG. 5 is a schematic view illustrating an exemplary example of the variable definition integration table shown in FIG. 4 according to one or more embodiments of the present invention. FIG. 6 is a schematic view illustrating an exemplary example of the variable definition location table shown in FIG. 4 according to one or more embodiments of the present invention.

Referring to FIG. 3 to FIG. 6, the storage 31 may be configured to store a plurality of process model definition files 6 (including process model definition files 60, 62, 64, . . . ) corresponding to the process model integration system 1. The process model definition files 6 may comply with various process model management definitions, for example but not limited to, the Business Process Modeling Notation (BPMN) or the Business Process Execution Language (BPEL).

Each of the process model definition files 6 may correspond to a process model 2. For example, the process model definition file 60 may correspond to the process model 20, the process model definition file 62 may correspond to the process model 22, and the process model definition profile 64 may correspond to the process model 24. Each of the process models 2 may comprise at least one artifact (i.e., one or more artifacts). For the purpose of simplicity, one artifact comprised in each of the process models 2 will be taken as an example, but this is not for the purpose of limitation. For example, an artifact 20a comprised in the process model 20, an artifact 22a comprised in the process model 22 and an artifact 24a comprised in the process model 24 will be taken as an example for description.

The artifact 20a may comprise at least one original variable definition D1 (i.e., one or more variable definitions) and a process model identity ID that corresponds to the process model 20. Likewise, the artifact 22a may comprise at least one original variable definition D1 (i.e., one or more variable definitions) and a process model identity ID that corresponds to the process model 22, and the artifact 24a may comprise at least one original variable definition D1 (i.e., one or more variable definitions) and a process model identity ID that corresponds to the process model 24. For the purpose of simplicity, one original variable definition D1 comprised in the artifact 20a, the artifact 22a and the artifact 24a respectively will be taken as an example, but this is not for the purpose of limitation. Additionally, it is assumed that the original variable definitions D1 comprised in the artifact 20a, the artifact 22a and the artifact 24a correspond to a same variable. In other words, the original variable definitions D1 comprised in the artifact 20a, the artifact 22a and the artifact 24a are definitions that a same variable has in the process models 20, 22 and 24 respectively before the process models 20, 22, 24 are integrated. Preferably, the same variable may refer to a global variable but not a local variable. The global variable means a variable that needs to be transferred between a plurality of artifacts 2, while the local variable means a variable that is merely used inside a process model 2 without being transferred to other process models 2.

The variable definition integration recorder 331 can be known from the process model definition files 6 stored in the storage 31 the artifact (e.g., the artifact 20a, the artifact 22a and the artifact 24a) comprised in each process model 2 as well as the original variable definition D1 and the process model identity ID recorded in the artifact. Thus, the variable definition integration recorder 331 can create a variable definition integration table 80 in the storage 31 according to the information.

The variable definition integration table 80 may comprise a new variable definition D2, and respective original variable definitions D1 and respective process model identities ID of the artifacts 20a, 22a and 24a. The new variable definition D2 and the respective original variable definitions D1 of the artifacts 20a, 22a and 24a correspond to a same variable. As described above, the original variable definitions D1 comprised in the artifact 20a, the artifact 22a and the artifact 24a are definitions that the same variable has in the process models 20, 22 and 24 respectively before the process models 20, 22, 24 are integrated; and the new variable definition D2 is the definition that the same variable has after the process models 20, 22, 24 are integrated. In other words, the original variable definition D1 of each artifact and the new variable definition D2 are definitions of a same variable before and after the corresponding process models 2 are integrated respectively. The new variable definition 2 may be identical to one of the original variable definitions D1, or different from any of the original variable definitions D1. Additionally, in this embodiment, the original variable definitions D1 and the new variable definition D2 of the artifacts 20a, 22a and 24a may each comprise a variable name and a variable type. In other embodiments, the new variable definition D2 and the original variable definitions D1 may each comprise only a variable name or only a variable type. In other embodiments, the new variable definition D2 and the original variable definitions D1 may each comprise other information in addition to the variable name and the variable type.

Taking FIG. 5 as an example, it is assumed that the variable name and the variable type comprised in the original variable definition D1 of the artifact 20a are “GD” and “String” respectively, the variable name and the variable type comprised in the original variable definition D1 of the artifact 22a are “Gender” and “Integer” respectively, and the variable name and the variable type comprised in the original variable definition D1 of the artifact 24a are “Gender” and “String” respectively; and further, it is assumed that the variable name and the variable type comprised in the new variable definition D2 are “Gender” and “String” respectively. Besides, it is assumed that the process model identities ID of the artifact 20a, the artifact 22a and the artifact 24a are “001” (corresponding to the process model 20), “002” (corresponding to the process model 22) and “003” (corresponding to the process model 24) respectively. On these assumptions, the variable definition integration table 80 may be as shown in FIG. 5. The aforesaid representations of the original variable definitions D1 and the process model identities ID are provided only as examples but not for limitation.

From the process model definition files 6 stored in the storage 31, the variable definition location recorder 333 can know the artifact (e.g., the artifact 20a, the artifact 22a and the artifact 24a) comprised in each process model 2 as well as the original variable definition D1 and the process model identity ID recorded in the artifact. Thus, the variable definition location recorder 333 may scan the process model definition files 6 respectively to search for variable definition locations L where the original variable definitions D1 are located in the corresponding process model definition files 6. Then, the variable definition location recorder 333 may create a variable definition location table 82 in the storage 31. The variable definition location table 82 may comprise the variable definition locations L where the original variable definitions D1 are located in the corresponding process model definition files 6.

Taking FIG. 6 as an example, it is assumed that the variable definition location L where the original variable definition D1 of the artifact 20a is located in the process model definition file 60 is “the 2^{nd} line of the 4^{th} region”, the variable definition location L where the original variable definition D1 of the artifact 22a is located in the process model definition file 62 is “the 6^{th} line of the 9^{th} region”, and the variable definition location L where the original variable definition D1 of the artifact 24a is located in the process model definition file 64 is “the 8^{th} line of the 7^{th} region”. On this assumption, the variable definition location table 82 may be as shown in FIG. 6. The aforesaid representations of the variable definition locations L are provided only as examples but not for limitation.

If one of the original variable definitions D1 is different from the new variable definition D2, the variable definition modifier 335 may be configured to modify the original variable definition D1 into the new variable definition D2 in the corresponding process model definition file 6 according to the variable definition integration table 80 and the variable definition location table 82. Specifically, the variable definition modifier 335 can know from the variable definition integration table 80 stored in the storage 31 which of the original variable definitions D1 needs to be modified and to which of the process model definition files 6 the original variable definition D1 that needs to be modified correspond. Besides, by means of the process model identities ID recorded in the variable definition integration table 80, modifying an original variable definition D1 corresponding to a local variable by the variable definition modifier 335 can be avoided. On the other hand, the variable definition modifier 335 can know from the variable definition location table 82 stored in the storage 31 the variable definition location L where the original variable definition D1 that needs to be modified is located in the corresponding process model definition file 6. Thereby, according to the variable definition integration table 80 and the variable definition location table 82, the variable definition modifier 335 can automatically and rapidly modify the original variable definition D1 that is different form the new variable definition D2 into the new variable definition D2 in the corresponding process model definition file 6.

Taking FIG. 5 and FIG. 6 as an example, the original variable definition D1 of the artifact 20a has a different variable name but a same variable type as compared to the new variable definition D2. Therefore, the variable definition modifier 335 can modify the original variable definition D1 located in the 2^{nd} line of the 4^{th} region in the process model definition file 60 into the new variable definition D2 (i.e., modify the variable name into “Gender”). As compared to the new variable definition D2, the original variable definition D1 of the artifact 22a has a same variable name but a different variable type. Therefore, the variable definition modifier 335 can modify the original variable definition D1 located in the 6^{th} line of the 9^{th} region in the process model definition file 62 into the new variable definition D2 (i.e., modify the variable type into “String”). As compared to the new variable definition D2, the original variable definition D1 of the artifact 24a has a same variable name and a same variable type. Therefore, it is unnecessary for the variable definition modifier 335 to modify the original variable definition D1 located in the 8^{th} line of the 7^{th} region in the process model definition file 64.

Optionally, the storage 31 may back up any of the original variable definitions D1 before the original variable definition D1 is modified by the variable definition modifier 335 into the new variable definition D2. Taking FIG. 4 as an example, the storage 31 may create a variable definition backup table 84 before any of the original variable definitions D1 is modified by the variable definition modifier 335 into the new variable definition D2, and the variable definition backup table 84 may be configured to record contents of the original variable definition D1 before being modified. Thus, any modified original variable definition D1 can be recovered according to the contents recorded in the variable definition backup table 84 after the original variable definition D1 has been modified by the variable definition modifier 335 into the new variable definition D2.

Take FIG. 5 and FIG. 6 as an example. After the original variable definition D1 located in the 2^{nd} line of the 4^{th} region in the process model definition file 60 has been modified by the variable definition modifier 335 into the new variable definition D2, the variable definition modifier 335 may also recover the original variable definition D1 located in the 2^{nd} line of the 4^{th} region in the process model definition file 60 (i.e., recover the variable name into “GD”) according to the variable definition backup table 84. Likewise, after the original variable definition D1 located in the 6^{th} line of the 9^{th} region in the process model definition file 62 has been modified by the variable definition modifier 335 into the new variable definition D2, the variable definition modifier 335 may also recover the original variable definition D1 located in the 6^{th} line of the 9^{th} region in the process model definition file 62 (i.e., recover the variable type into “Integer”) according to the variable definition backup table 84.

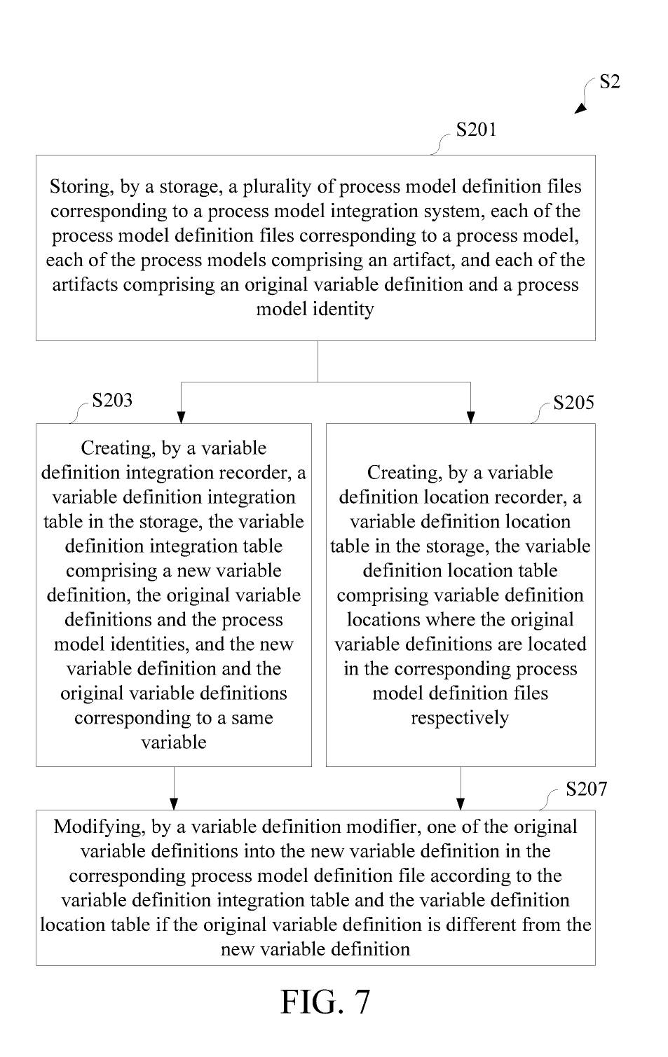

Another embodiment (called “the second embodiment” hereinafter) of the present invention is a variable definition modification method for a process model integration system. FIG. 7 is a flowchart diagram illustrating an exemplary example of the variable definition modification method for a process model integration system according to one or more embodiments of the present invention. Sequences of all steps described in the second embodiment and exemplary examples thereof can be arbitrarily adjusted without departing from the spirits of the present invention and shall not be construed to limit the scope of the present invention.

As shown in FIG. 7, the variable definition modification method S2 may comprise the following steps: storing, by a storage, a plurality of process model definition files corresponding to the process model integration system, each of the process model definition files corresponding to a process model, each of the process models comprising an artifact, and each of the artifacts comprising an original variable definition and a process model identity (i.e., step S201); creating, by a variable definition integration recorder, a variable definition integration table in the storage, the variable definition integration table comprising a new variable definition, the original variable definitions and the process model identities, and the new variable definition and the original variable definitions corresponding to a same variable (i.e., step S203); creating, by a variable definition location recorder, a variable definition location table in the storage, the variable definition location table comprising variable definition locations where the original variable definitions are located in the corresponding process model definition files respectively (i.e., step S205); and modifying, by a variable definition modifier, one of the original variable definitions into the new variable definition in the corresponding process model definition file according to the variable definition integration table and the variable definition location table if the original variable definition is different from the new variable definition (i.e., step S207). The variable definition modification method S2 may substantially be used for the variable definition modification device 3 of the first embodiment, so the storage, the variable definition integration recorder, the variable definition location recorder and the variable definition modifier described in the second embodiment may substantially correspond to the storage 31, the variable definition integration recorder 331, the variable definition location recorder 333 and the variable definition modifier 335 described in the first embodiment.

As an exemplary example of the second embodiment, the original variable definitions and the new variable definition may each comprise a variable name and a variable type in the variable definition modification method S2.

As an exemplary example of the second embodiment, the variable definition modification method S2 may further comprise the following step of: backing up, by the storage, the original variable definition before the variable definition modifier modifies the original variable definition into the new variable definition.

The variable definition modification method S2 substantially comprises steps corresponding to all operations of the variable definition modification device 3. Because all the corresponding steps comprised in the variable definition modification method S2 can be readily known by those of ordinary skill in the art from the descriptions of the variable definition modification device 3, these corresponding steps will not be further described herein.

In conclusion, in the present invention, a variable definition integration table may be provided for a process model integration system used for integrating a plurality of process models, and the variable definition integration table is configured to record a new variable definition, at least one original variable definition and at least one corresponding process model identity for a same variable. In this way, not only correspondence of variable definitions can be created for a same variable, but also a corresponding process model of each of the original variable definitions can be recorded. When one of the original variable definitions needs to be modified, the one of the process models to which the original variable definition to be modified corresponds (i.e., the process model definition file to which the original variable definition corresponds) can be known immediately. In the present invention, a variable definition location table may also be provided, and the variable definition location table is configured to record a variable definition location where each of the original variable definitions is located in the corresponding process model definition file. Thus, when one of the original variable definitions needs to be modified, the location where the original variable definition is located in the corresponding process model definition file can be known immediately. In the present invention, if one of the original variable definitions is different from the new variable definition for a same variable, the original variable definition may be modified into the new variable definition in the corresponding process model definition file according to the variable definition integration table and the variable definition location table. Thereby, the same variable can correspond to the same variable definition in all of the process models. Based on these operations, the present invention can indeed provide a more effective variable definition processing technology for the process model integration system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A variable definition modification device for a process model integration system, comprising:
a storage, being configured to store a plurality of process model definition files corresponding to the process model integration system, each of the process model definition files corresponding to a process model, each of the process models comprising an artifact, and each of the artifacts comprising an original variable definition and a process model identity;
a variable definition integration recorder electrically connected to the storage, being configured to create a variable definition integration table in the storage, the variable definition integration table comprising a new variable definition, the original variable definitions and the process model identities, and the new variable definition and the original variable definitions corresponding to a same variable;
a variable definition location recorder electrically connected to the storage, being configured to create a variable definition location table in the storage, the variable definition location table comprising variable definition locations where the original variable definitions are located in the corresponding process model definition files respectively; and
a variable definition modifier electrically connected to the storage, being configured to modify one of the original variable definitions into the new variable definition in the corresponding process model definition file according to the variable definition integration table and the variable definition location table if the original variable definition is different from the new variable definition.

2. The variable definition modification device of claim 1, wherein the original variable definitions and the new variable definition each comprise a variable name and a variable type.

3. The variable definition modification device of claim 1, wherein the storage further backs up the original variable definition before the variable definition modifier modifies the original variable definition into the new variable definition.

4. A variable definition modification method for a process model integration system, being used in a variable definition modification device, the variable definition modification device comprising a storage, a variable definition integration recorder, a variable definition location recorder and a variable definition modifier, the variable definition modification method comprising:
storing, by the storage, a plurality of process model definition files corresponding to the process model integration system, each of the process model definition files corresponding to a process model, each of the process models comprising an artifact, and each of the artifacts comprising an original variable definition and a process model identity;
creating, by the variable definition integration recorder, a variable definition integration table in the storage, the variable definition integration table comprising a new variable definition, the original variable definitions and the process model identities, and the new variable definition and the original variable definitions corresponding to a same variable;
creating, by the variable definition location recorder, a variable definition location table in the storage, the variable definition location table comprising variable definition locations where the original variable definitions are located in the corresponding process model definition files respectively; and
modifying, by the variable definition modifier, one of the original variable definitions into the new variable definition in the corresponding process model definition file according to the variable definition integration table and the variable definition location table if the original variable definition is different from the new variable definition.

5. The variable definition modification method of claim 4, wherein the original variable definitions and the new variable definition each comprise a variable name and a variable type.

6. The variable definition modification method of claim 4, further comprising:
backing up, by the storage, the original variable definition before the variable definition modifier modifies the original variable definition into the new variable definition.
